(19) United States
(12) Patent Application Publication
(10) Pub. No.: US 2017/0297211 A1
(43) Pub. Date: Oct. 19, 2017

(54) Bolt Cutter

(71) Applicant: WEZAG GmbH Werkzeugfabrik, Stadtallendorf (DE)

(72) Inventor: Roman Zinser, Neustadt (DE)

(21) Appl. No.: 15/461,738

(22) Filed: Mar. 17, 2017

(30) Foreign Application Priority Data
Apr. 14, 2016 (EP) 16 165 300.1

(51) Int. Cl. B26B 13/16; B23D 29/02

(52) U.S. Cl. CPC B26B 13/16; B23D 29/023

(57) ABSTRACT

The invention relates to a bolt cutter (1) which can be used for cutting a workpiece, especially a workpiece that is bolt-like. The bolt cutter comprises a fixed hand lever (3) and a movable hand lever (2). A cutting jaw (8) is fixedly connected to the fixed hand lever (3). The movable hand lever (2) via a ratchet gear (7) is coupled to a movable cutting jaw (6).

In an opening position of the cutting jaws (6, 8) the movable cutting jaw (6) lies against a rest (55) supported by a support spring (54). By manual application of an opening force, the movable cutting jaw (6) can be moved into an enlarged opening position from the mentioned opening position by pressurizing the support spring (54). When the manually applied opening force is removed, the movable cutting jaw (6) automatically returns to the opening position from the enlarged opening position due to the support spring (54).

### CROSS REFERENCE TO RELATED APPLICATIONS

This application claims priority to co-pending European Patent Application No. EP 16 165 300.1 filed Apr. 4, 2016.

### FIELD OF THE INVENTION

The present invention generally relates to a bolt cutter, which enables cutting a workpiece, especially a wire, a wire rope, a cable, a bolt or similar.

### BACKGROUND OF THE INVENTION

Side cutting pliers are known from document DE 298 01 199 U1. A base body consisting of two half-shells forms a fixed hand lever and a fixed cutting jaw. Between the two half-shells a cutting jaw is pivotably supported on the base body via a swivel pin. This pivotable cutting jaw on its side turned away from the blade with respect to the pivot bearing comprises a ratchet toothing. On the base body, via a further pivot bearing a movable hand lever is pivotably supported. On the movable hand lever a pushing rod in turn is supported pivotably. The pushing rod is brought into engagement with the ratchet toothing of the movable cutting jaw via a spring, in which way a ratchet gear is formed by which by manual actuation of the hand levers the cutting jaws can be closed. A closing position of the cutting jaws once reached is secured when the hand levers are released or opened by a pawl engaging with the ratchet toothing of the movable cutting jaw. By an unlocking lever extending from the side of the head of the side cutting pliers the pawl can be manually unlocked. A tension spring biases the movable cutting jaw in an opening direction. After fully running through the cutting stroke or a manual unlocking of the pawl, the movable cutting jaw is automatically moved in the opening direction by the tension spring. When the opening position is reached, the cutting jaw due to the biasing by the tension spring comes into contact with a stop supported by the base body.

### SUMMARY OF THE INVENTION

The invention relates to a special type of pliers, that is, a bolt cutter, which serves for cutting a workpiece. In this bolt cutter, preferably blades are employed that are not sickle-shaped, as they are used for so-called cable cutters and which during the cutting stroke are guided past each other. Rather than that straight blades can, for example, be employed, which across the cutting stroke form a V with a varying opening angle. Preferably, at the end of the cutting stroke after cutting the workpiece the two blades contact each other in the same plane. The invention comprises embodiments in which the incising and cutting of the workpiece is done by both blades, as well as embodiments in which one blade mainly supports the workpiece while the other blade mainly cuts the workpiece, where in this case the first-mentioned blade may be blunt. For the bolt cutter according to the invention, the two cutting jaws are moved in the manner of scissors. For this purpose, the movable cutting jaw is pivotably supported with respect to the fixed cutting jaw via a pivot bearing.

With the novel bolt cutter according to the invention, it is possible to suggest a bolt cutter which is improved with respect to its handling, especially for inserting a workpiece into a receptacle formed by cutting knives.

Furthermore, according to the invention no bolt cutter is employed in which (as in scissors) the movable hand lever and the movable cutting jaw are fixedly connected with each other or are only connected with each other by a simple toggle lever drive. Rather than that, the movable cutting jaw is driven by a movable hand lever via a ratchet gear (while a toggle lever drive may additionally be employed). The ratchet gear makes it possible to break up the cutting stroke of the cutting jaws into separate partial strokes, where in each partial stroke of the cutting jaws, a completely closing stroke of the hand levers from an opening position of the hand levers into a closing position of the hand levers is caused while between the separate partial strokes the hand levers are brought back into the opening position. This results in the hand levers going through an accumulated closing stroke over the entire cutting stroke of the cutting jaws, which is roughly made up of the product of the number of closing strokes or partial strokes of the cutting stroke on the one hand and the closing stroke of the hand levers on the other hand. Therefore, using the ratchet gear enables a great transmission of force, which results in great cutting forces being able to be produced for comparatively short hand levers and therefore a compact mode of construction.

According to the invention, for such a bolt cutter it is suggested that the opening position (in deviation to the prior art mentioned in the beginning) is not set by a fixed stop, but is rather set by the cutting jaw resting against a stop supported by a support spring (where the stop may also be formed by the front face of the support spring itself). By manual application of an opening force onto the movable cutting jaw, the latter can be moved from the opening position (with a movement of the stop and an increase of the biasing of the support spring) into an enlarged opening position. The enlarged opening position then can be used to insert the workpiece to be cut into a receptacle of the bolt cutter limited by cutting knives. Generally, for a conventional bolt cutter with a fixed stop to set the opening position, the stop may also be positioned in such a way that a large opening of the receptacle corresponding to the opening position enlarged according to the invention results. Then, however, starting from this very wide opening of the receptacle it would be necessary to run through a plurality of partial strokes of the cutting stroke before the receptacle for the workpiece would be closed so far that the actual cutting process may begin. Therefore, for the bolt cutter according to prior art the conflict of aims of
on the one hand keeping the size of the opening of the receptacle for the workpiece in the opening position as small as possible to reduce the number of partial strokes and
on the other hand to make the opening of the receptacle as large as possible to enable an insertion of the workpiece or to make this as easy as possible

is to be solved. Preferably, when the manually applied opening force is reduced or removed, the movable cutting jaw is (automatically) returned into the opening position from the enlarged opening position due to the support spring. In the opening position then the cutting stroke begins, in which way additional closing strokes of the hand levers for bringing about the opening position are avoided according to the invention.

Preferably
for the movement of the movable cutting jaw from the opening position into the enlarged opening position by manual application of an opening force and/or
for the automatic movement of the movable cutting jaw back from the enlarged opening position into the opening position due to the support spring

a pawl of the ratchet gear and/or a pushing rod of the ratchet gear has to be released. This release of the pawl and/or the pushing rod can be done manually by manual actuation of at least one releasing means such as a releasing lever which moves the pawl and/or the pushing rod away from the ratchet toothing of the ratchet gear. Alternatively or cumulatively it is possible that a release of the pawl and/or the pushing rod is done by transferring the hand levers into a special position such as an enlarged opening position, in which a release of the pawl and/or the pushing rod occurs or a release position of the pawl and/or a pushing rod previously brought about manually before is kept up. Preferably, for the release of the pawl and the pushing rod and for keeping up the release position an embodiment according to European patent application EP 15 191 264.9 (not pre-published) is employed, according to which the hand levers during the cutting stroke of the cutting jaws are repeatedly moved between an opening position of the hand levers and a closing position of the hand levers. Here, the pushing rod and the pawl are engaged with a ratchet toothing of the movable cutting jaw, while the hand levers can be transferred into an enlarged opening position in which the pushing rod and the pawl are not in engagement with the ratchet toothing of the movable cutting jaw. The related disclosure of the (not pre-published) document EP 15 191 264.9 is incorporated by reference into the present application. It is therefore possible that according to EP 15 191 264.9 the hand levers are brought into an enlarged opening position by the user. In this way the cutting jaws can also be manually moved into the enlarged opening position and after insertion of the workpiece into the receptacle the automatic closing due to the support spring can occur.

For applying the manual opening force onto the movable cutting jaw, there are numerous possibilities, which include a direct and an indirect application of the opening force onto the movable cutting jaw. For one embodiment of the bolt cutter, the cutting blades (formed integrally by the cutting jaws or supported by the latter) form a receptacle for a workpiece. In the enlarged opening position (and possibly also in the opening position), the receptacle has an insertion opening via which the workpiece can be inserted into the receptacle in an insertion direction.

For a first embodiment of manual application of the opening force, the movable cutting jaw comprises an actuation surface. The actuation surface for this embodiment is placed in front of the receptacle in the direction of insertion. For inserting the workpiece into the receptacle, the manual opening force can be applied onto the actuation surface of the movable cutting jaw by the user via the workpiece. The workpiece, therefore, presses the movable cutting jaw from the opening position into the enlarged opening position via the actuation surface, in which way the insertion opening is created or enlarged and the workpiece can slide into the receptacle in the insertion direction along the actuation surface. When the workpiece is arranged in the receptacle, due to the influence of the support spring the cutting jaws may “snap closed” again, while at least partly closing the insertion opening of the receptacle.

For a second embodiment (which may be employed alternatively or cumulatively to the first embodiment), the movable cutting jaw also comprises an actuation surface, via which a manual opening force may be applied. In this case, the actuation surface protrudes laterally from a head of the bolt cutter in the opening position so that it can be directly gripped by the user or actuated in another way. By pressing onto or pulling on the actuation surface, the movable cutting jaw then can be brought from the opening position into the enlarged opening position by the user.

For the design of the actuation surface there are numerous possibilities. For one embodiment, the actuation surface is formed by an actuation element, especially a hook. This can be arranged in an outer end portion of a ratchet toothing of the movable cutting jaw with which the ratchet gear is formed, said outer end portion protruding laterally from the pliers head.

For another embodiment, at least one cutting jaw comprises a securing element. The securing element closes an insertion opening of the receptacle for the workpiece still present in the opening position at least partially, to avoid an unintended escape of the workpiece from the receptacle after it has been inserted in the enlarged opening position.

For the design of the securing element there are numerous possibilities. For example, the securing element may be a slide held on the cutting jaw, a swivel bar held pivotably on the cutting jaw or similar. An especially simple embodiment of the securing element is given when the securing element is formed by a protrusion or a hook of the cutting jaw which extends towards the other cutting jaw opposite to the blade of the cutting jaw on which the securing element is formed.

For the design and the dimensions of the opening position, the enlarged opening position and the insertion opening in the opening position there are numerous possibilities covered by the invention. For a special embodiment, the insertion opening in the opening position comprises a first insertion cross-section, while it comprises a second insertion cross-section in the enlarged opening position. For the case when the aforementioned securing element is used, at least the second insertion cross-section, preferably the first insertion cross-section and the second insertion cross-section, is/are limited by the securing element. According to the invention, the second insertion cross-section in the enlarged opening position is chosen to be larger than the cross-section of the workpiece intended to be used, so that in the enlarged opening position the insertion of the workpiece intended to be used into the receptacle is possible through the second insertion cross-section. The first insertion cross-section in the opening position, however, is smaller than the cross-section of a workpiece intended to be used. In this way, the workpiece that has once been inserted into the receptacle in the enlarged opening position cannot escape from the receptacle through the first insertion cross-section after the automatic return into the opening position.

For the case that the bolt cutter is intended for several specific workpieces, the second insertion cross-section might be chosen to be so large that all cross-sections of the specific workpieces can pass through the insertion opening. In this case, the first insertion cross-section can merely be smaller than the cross-section of the largest intended workpiece. Preferably, however, it is smaller than the cross-section of all intended workpieces.

It is possible that there is a conflict of aims with respect to the dimensioning of the opening spring:
On the one hand, a stiff opening spring with a great opening force can be desired to move the movable cutting jaw (possibly by overcoming the ratchet effect of the ratchet gear, a possible friction or similar) into the opening position.
On the other hand, possibly for the movement from the opening position into the enlarged opening position the user may have to work against the effect of the opening spring, so that it is advantageous if the opening spring creates a small opening force or is not designed to be very stiff.

This conflict of aims can for example be solved by the opening spring only being coupled with the movable cutting jaw up to the reaching of the opening position, while it is decoupled from the movable cutting jaw during the movement from the opening position towards the enlarged opening position. This can for example happen by the opening spring resting only against the movable cutting jaw as a compression spring and when the opening position is contacting a stop so that it cannot further follow the movable cutting jaw. For one solution according to the invention, the opening spring generally also biases the movable cutting jaw for the movement from the opening position into the enlarged opening position. For one proposal of the invention, however, with the change of the swivel angle of the movable cutting jaw towards the enlarged opening position the moment exerted by the opening spring on the movable cutting jaw decreases, in which way the opening forces to be applied by the user are reduced.

The previously explained reduction of the moment applied onto the movable cutting jaw by the opening spring can be provided in many ways. For example, an opening spring can be used which comprises a non-linearity which leads to a reduction of the moment or the opening spring is a tension spring or compression spring the displacement of which decreases from the closing position in the direction of the opening position (and the enlarged opening position). Alternatively or cumulatively, according to one embodiment the invention suggests that a reduction of the moment exerted by the opening spring is provided by a lever arm with which the opening spring biases the movable cutting jaw with respect to the swivel bearing, said lever arm decreasing with the change of the pivot angle of the movable cutting jaw towards the opening position and/or the enlarged opening position.

For the basic design of the bolt cutter there are multiple possibilities. For one embodiment of the bolt cutter, its head is formed with three plates arranged one above the other, which for example can have been manufactured as formed parts or pressed parts, as cast parts or milled parts. For such a plate construction, the outer plate forms the fixed cutting jaw (and preferably also the fixed hand lever). The other outer plate forms a cover plate, which preferably does not cover the two blades and e. g. extends only up to the pivot bearing of the two cutting jaws. By the cover plate for example the ratchet drive, a possible toggle lever drive and further construction elements such as springs can be covered. It is also possible that on the two mentioned outer plates bolts such as pivot bolts or bolts or stops for spring bases of springs are supported. Between the two mentioned outer plates, the third plate is arranged which forms the movable cutting jaw.

For the mounting of the cover plate onto the other outer plate there are multiple possibilities. According to one embodiment, the cover plate is only fixed below the movable cutting jaw (that is, on the side turned towards the hand levers from the movable cutting jaw) to the other outer plate. Accordingly, from this mounting region the cover plate protrudes freely towards the receptacle and the blades. Because in the longitudinal region of the movable cutting jaw no further mounting points for the cover plate are present, an especially compact construction results without the necessity to forego the covering effect of the cover plate in this region.

For the general design of the drive kinematics of the bolt cutter there are diverse possibilities known from prior art, where in any case in the framework of the invention a ratchet drive is employed. For a special embodiment of the bolt cutter it is suggested that the movable hand lever is supported pivotably on the fixed hand lever via a pivot bearing. The movable hand lever comprises a hand lever part which extends from the pivot bearing in a direction away from the movable hand lever. A pushing rod is linked via a pivot bearing to the end region of the hand lever part which is turned away from the pivot bearing. The pushing rod in the end region turned away from the pivot bearing has a ratchet toothing which may also have only one engaging tooth. The ratchet toothing can be brought into engagement with a corresponding ratchet toothing of the movable cutting jaw. The hand lever part forms a first toggle lever. The pushing rod forms a second toggle lever. The pivot bearing between the hand lever part and the pushing rod forms a toggle lever joint. The hand lever part, the pushing rod and the toggle lever joint form a toggle lever drive. In addition to the mentioned advantageous ratchet effect leading to a compact construction, for this embodiment of the invention, a further optimization of the force and movement conditions can be provided due to the explained use of a toggle lever drive.

In a further embodiment, a spring-loaded pawl cooperates with the ratchet toothing of the movable cutting jaw. By engaging the ratchet toothing of the movable cutting jaw the pawl blocks an opening of the cutting jaws during the cutting stroke. After a full course through the cutting stroke, bringing the hand levers from an opening position into an enlarged opening position in an embodiment according to EP 15 191 264.9 and/or a manual unblocking of the pawl, the pawl, however, does not cause a blocking effect in the ratchet toothing of the movable cutting jaw. Due to the loss of the blocking effect, an opening of the movable cutting jaw by the opening spring into the opening position and/or manual opening of the movable cutting jaw into the enlarged opening position is possible.

It is possible that the fixed and/or movable cutting jaw directly forms a cutting knife or a supporting knife. In one embodiment, at least one cutting jaw detachably holds a cutting knife so that it may be replaced when it is worn down and/or with the same bolt cutter cutting knives with different blade geometries and/or longitudinal contours of the cutting knives and geometries of the receptacle formed can be used to be able to cut workpieces with different geometries and/or materials. Preferably, cutting knives are detachably held on the two cutting jaws.

It is possible that the cutting knives are held by the corresponding cutting jaw via a receptacle or guide with a latching device or locking device, a threaded connection or similar. For one embodiment, (at least) one cutting jaw comprises a receptacle into which the cutting knife can be inserted form-fittingly with respect to at least one degree of freedom. In this way at least with respect to one degree of freedom the mounting according to the specification can be guaranteed. For example, the cutting knife in the projection into the head plane of the bolt cutter can comprise an outer contour which can be inserted form-fittingly into a corresponding cross-section contour of the receptacle of the cutting jaw. Here, the receptacle is a recess with the mentioned cross-section contour (with open or closed boundaries), which in a direction vertical to the head plane is formed into the cutting jaw so that the cross-section contour of the receptacle extends in the head plane. With the form-fitting insertion of the cutting knife into the receptacle, the cutting knife is already form-fittingly fixed in all directions of the head plane. In a first direction vertical to the head plane of the bolt cutter, the cutting knife additionally can support itself to the floor of the receptacle. In this case only a securing of the cutting knife in the opposite direction vertically to the head plane of the bolt cutter is required which can for example be done by a screw which with its head presses the cutting knife into the receptacle.

It is possible that further cutting knives for replacing a damaged cutting knife of the bolt cutter or for working of workpieces with different geometries or materials are separately carried by the user of the bolt cutter. According to another embodiment, the bolt cutter comprises a receptacle for further replacement cutting knives (for example in the region of a fixed cutting jaw and the base body forming the fixed hand lever, an outer plate or the cover plate). For the fixing of the replacing cutting knives in the receptacle there are various possibilities. For example, the replacement cutting knife can be latched, locked or otherwise fixed in a corresponding holder or recess forming the receptacle. In the simplest case, the receptacle is formed by a bore, via which the replacement cutting knife can be screwed with the bolt cutter. Here, as the screw even a screw can be used by which then the cutting knife can also be fixed to the corresponding cutting jaw for use.

Advantageous developments of the invention result from the claims, the description and the drawings. The advantages of features and of combinations of a plurality of features mentioned at the beginning of the description only serve as examples and may be used alternatively or cumulatively without the necessity of embodiments according to the invention having to obtain these advantages. Without changing the scope of protection as defined by the enclosed claims, the following applies with respect to the disclosure of the original application and the patent: further features may be taken from the drawings, in particular from the illustrated designs and the dimensions of a plurality of components with respect to one another as well as from their relative arrangement and their operative connection. The combination of features of different embodiments of the invention or of features of different claims independent of the chosen references of the claims is also possible, and it is motivated herewith. This also relates to features which are illustrated in separate drawings, or which are mentioned when describing them. These features may also be combined with features of different claims. Furthermore, it is possible that further embodiments of the invention do not have the features mentioned in the claims.

The number of the features mentioned in the claims and in the description is to be understood to cover this exact number and a greater number than the mentioned number without having to explicitly use the adverb “at least”. For example, if an element is mentioned, this is to be understood such that there is exactly one element or there are two elements or more elements. Additional features may be added to these features, or these features may be the only features of the respective product.

The reference signs contained in the claims are not limiting the extent of the matter protected by the claims. Their sole function is to make the claims easier to understand.

Other features and advantages of the present invention will become apparent to one with skill in the art upon examination of the following drawings and the detailed description. It is intended that all such additional features and advantages be included herein within the scope of the present invention, as defined by the claims.

### BRIEF DESCRIPTION OF THE DRAWINGS

The invention can be better understood with reference to the following drawings. The components in the drawings are not necessarily to scale, emphasis instead being placed upon clearly illustrating the principles of the present invention. In the drawings, like reference numerals designate corresponding parts throughout the several views.

FIG. 1 shows a bolt cutter in a front view.

FIG. 2 shows the bolt cutter according to FIG. 1 in a 3-D view seen inclined from the back.

FIG. 3 shows the bolt cutter according to FIGS. 1 and 2 in a view corresponding to FIG. 2, where in this case a fixed cutting jaw is disassembled.

FIG. 4 shows the bolt cutter according to FIGS. 1 to 3 in a 3-D view seen inclined from the bottom, where a cover plate is shown as partially cut away.

FIG. 5 shows a detail of the bolt cutter according to FIGS. 1 to 4 from the back in a partially disassembled state in the region of a ratchet gear with a toggle lever drive.

FIGS. 6 to 10 show the bolt cutter according to FIGS. 1 to 5 in different operating positions, that is, according to FIG. 6 in an opening position of the cutting jaws, according to FIG. 7 in an enlarged opening position of the cutting jaws, according to FIG. 8 in the opening position restored after inserting a workpiece, according to FIG. 9 during the cutting stroke with a double-sided incision into the workpiece and according to FIG. 10 in the closing position of the cutting jaws at the end of the cutting stroke.

### DETAILED DESCRIPTION

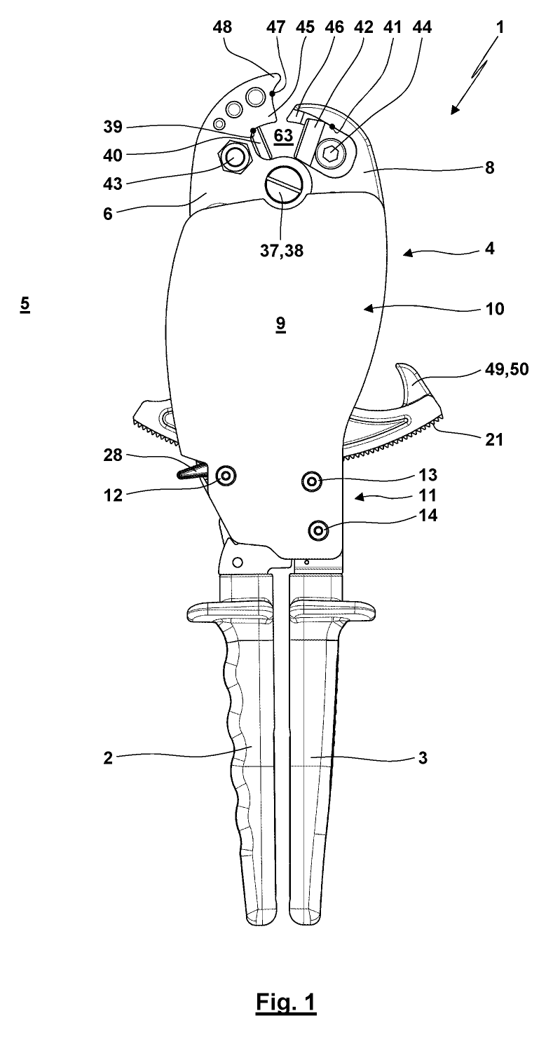

Referring now in greater detail to the drawings, FIG. 1 illustrates a bolt cutter 1, which substantially comprises a movable hand lever 2 and a fixed hand lever 3 and a head 4. The head 4 has a head plane 5, which is oriented in parallel to the plane of the drawing according to FIG. 1, 5 and in which the movable hand lever 2 is pivoted and other movable construction elements (such as a movable cutting jaw 6, springs and construction elements of a ratchet gear 7) move.

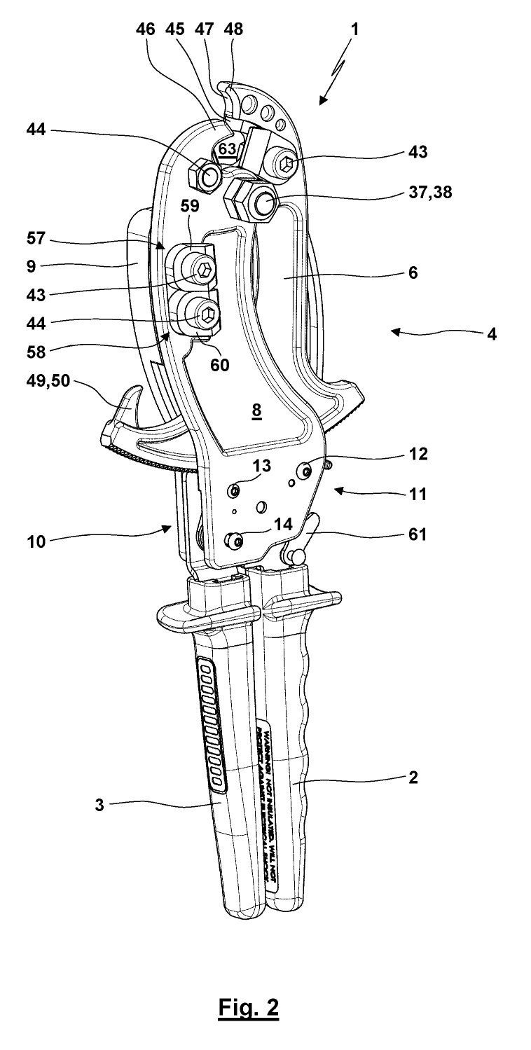

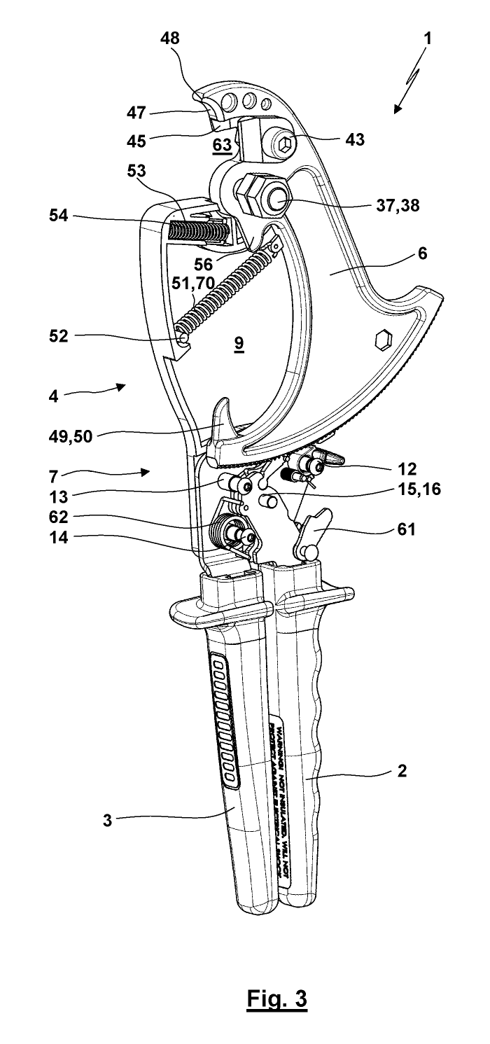

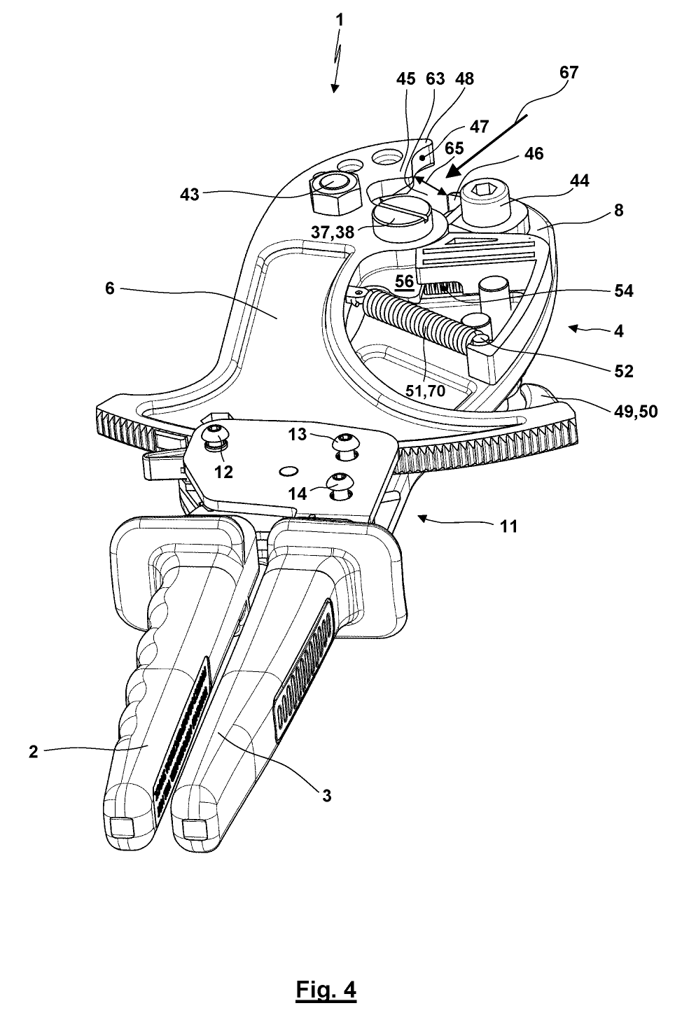

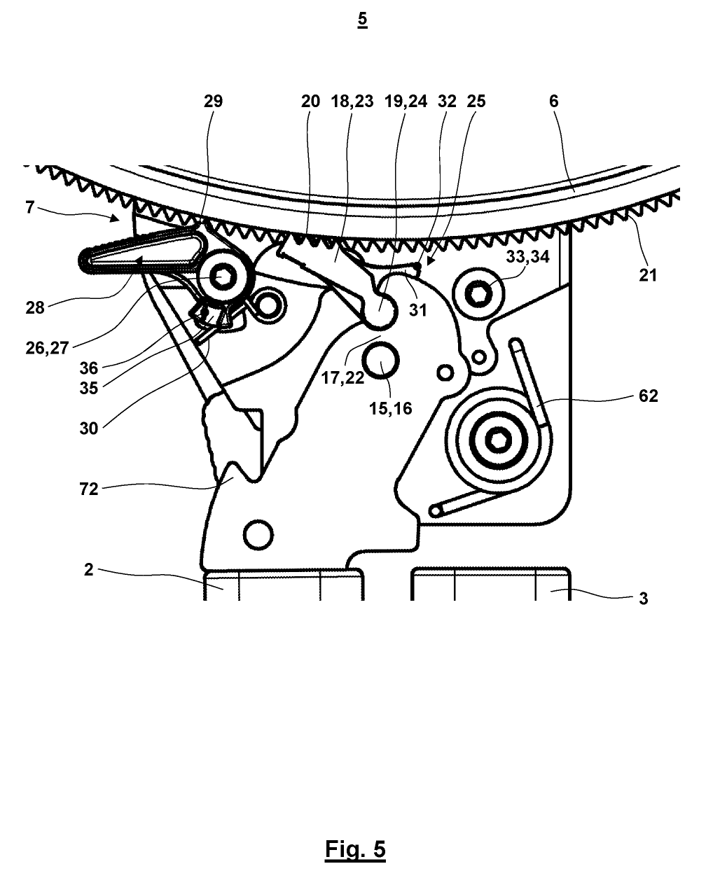

As can be seen best in FIG. 2, the fixed hand lever 3, a fixed cutting jaw 8 and a cover plate 9 form a rigid base body 10. The fixed hand lever 3, the cover plate 9 and the fixed cutting jaw 8 are fixedly connected to each other in the region of an overlap 11 by transverse bolts 12, 13, 14 oriented transverse to the head plane 5. On the side turned away from the hand levers 2, 3 the cover plate 9 and the fixed cutting jaw 8 freely protrude from the overlap 11. The cutting jaw 8 and the cover plate 9 form a kind of housing for the ratchet gear 7 and for further construction elements of the bolt cutter 1. The housing is closed vertically to the head plane 5 and partially open in the transverse direction so that the movable cutting jaw 6 can extend from this housing in both transverse directions. The base body 10 supports or forms a bearing for all further construction elements of the bolt cutter 1, especially the movable hand lever 2 and the ratchet gear 7. While the fixed hand lever 3 and the cover plate 9 directly contact each other, between these two and the fixed cutting jaw 8, an interspace is formed in which the movable cutting jaw 6, construction elements of the ratchet gear 7 and the movable hand lever 2 extend.

The movable hand lever 2 is supported pivotably by the base body 10 via a (second) pivot bearing 15, which is here is a transverse bolt 16. The movable hand lever 2 comprises a hand lever part 17 extending from the pivot bearing 15 in a direction away from a grip region of the movable hand lever 2. In the end portion of the hand lever part 17 from which the pivot bearing 15 is turned away, in a (third) pivot bearing 19 a pushing rod 18 is linked to the movable hand lever part 2. In the end region turned away from the pivot bearing 19 (which may also be only one ratchet tooth or an engagement element) the pushing rod 18 comprises a (second) ratchet toothing 20. This ratchet toothing 20 of the pushing rod 18 can be brought into engagement with a (first) corresponding ratchet toothing 21 of the movable cutting jaw 6.

The hand lever part 17 forms a first toggle lever 22. The pushing rod 18 forms a second toggle lever 23. The pivot bearing 19 forms a toggle lever joint 24. Therefore, the hand lever part 17, the pushing rod 18 and the pivot bearing 19 form a toggle lever drive 25.

Furthermore, via a pivot support 26 (which here is a pivot bolt 27) a pawl 28 is pivotably supported at the base body 10. The pawl 28 has a ratchet toothing 29 (which may also be just one ratchet tooth or an engagement element). With a spring 30 (here a leg spring) the pawl 28 is biased towards the ratchet toothing 21, in which way the ratchet toothing 29 of the pawl 28 engages with the ratchet toothing 21 of the movable cutting jaw 6. The ratchet toothing 21, the pawl 28 and the pushing rod 18 form the ratchet gear 7, which for the embodiment shown is achieved with the integration of the toggle lever drive 25 for driving the pushing rod 18.

By a spring also the pushing rod 18 is biased towards the ratchet toothing 21, so that during the normal closing stroke of the hand levers 2, 3 the ratchet toothings 20, 21 engage with each other. This engagement for the closing movement couples the movement of the pushing rod 18 to the movement of the cutting jaw 6 for closing the same, while for an opening movement of the hand levers 2, 3, in the way of a ratchet the pushing rod 18 can glide with its ratchet toothing 20 along the ratchet toothing 21.

It is possible that the pushing rod 18 comprises an protrusion 31, which has no function for the normal movement between the opening position and the closing position of the hand levers 2, 3. If, however, the hand levers 2, 3 are manually brought into an enlarged opening position, with a stop surface 32 the protrusion 31 contacts a stop 33 held by the base body 10, here a transverse bolt 34. Due to the support of the pushing rod 18 by the stop surface 32 on the stop 33 the further opening of the hand levers 2, 3 into the enlarged opening position leads to a pivoting of the pushing rod 18 away from the ratchet toothing 21, in which way the ratchet toothings 20, 21 disengage with each other. The pawl 28 prevents an opening movement of the cutting jaw 6 during the cutting stroke, especially during the ratchet-like movement of the pushing rod 18 relative to the cutting jaw 6, while for the closing movement of the cutting jaw 6 caused by the movement of the pushing rod 18 the ratchet toothing 29 in a ratchet-like way glides along the ratchet toothing 21.

The pawl 28 has a protrusion 35, which forms a stop surface 36. In the opening position of the hand levers 2, 3, a nose 72 of the hand lever 2 contacts a front side of the protrusion 35 located radial outside with respect to the pivot bearing 26. In this way in the opening position a limitation of the opening movement is achieved. If in this opening position of the hand levers 2, 3, however, the pawl 28 is unlocked in that the pawl 28 is moved away from the ratchet toothing 21 by a finger of the user, the nose 72 is able to pass the front side of the projection 35. Then, a movement of the hand lever 2 into an enlarged opening position is possible. In the enlarged opening position the nose 72 reaches behind the protrusion 35 and contacts the stop surface 36. In this way, in the enlarged opening position of the hand levers 2, 3 the pawl 28 is fixed in a position pivoted away from the ratchet toothing 21. With guiding the hand lever 2 back from the enlarged opening position into the opening position, the nose 72 glides along the stop surface 36. When the nose 72 has completely passed the stop surface 36, in the opening position the pawl 28 is moved again towards the ratchet toothing 21 which is due to the spring 30.

With respect to
the automatic release of the pushing rod 18 from the ratchet toothing 21 due to the movement of the hand lever 2,
the limiting of the opening movement of the hand lever with the protrusion 35 of the pawl 28,
the manual unlocking of the pawl 28 and fixing of the pawl 28 in the unlocked state by the hand lever 2 in the enlarged opening position and
the automatic restoration of the locking effect of the pawl 28 with the movement of the hand lever 2 from the enlarged opening position of the hand lever into the opening position of the hand lever 2 and/or
the arrangement and design of the construction elements concerned,

reference is made to the (not pre-published) European patent application EP 15 191 264.9, which in this respect is incorporated by reference into the disclosure of the present patent application.

By a (first) pivot bearing 37, here a pivot bolt 38, the cutting jaw 6 is movably supported at the cutting jaw 8. In the end portion turned towards the hand levers 2, 3, the cutting jaw 6 forms a ratchet toothing 21, which extends concentrically to the pivot bearing 37. The ratchet toothing 21 extends approximately over a peripheral angle of 60° to 90°. On the side opposed to the ratchet toothing 21 with respect to the pivot bearing 37, the cutting jaw 6 forms a receptacle 39 for a cutting knife 40. In the corresponding receptacle 41, a cutting knife 42 of the cutting jaw 8 is arranged. Via fixing screws 43, 44, which are screwed into the corresponding cutting jaws 6, 8, the cutting knives 40, 42 are secured and fixed in the (second) receptacles 39, 41. The cutting knifes 40, 42 have straight cutting edges. The cutting edges of the cutting knives 40, 42 are arranged in recesses or undercuts of the cutting jaws 6, 8, so that the cutting jaws 6, 8 protrude from the cutting edges of the cutting knives 40, 42 in a position radially outwards with respect to the pivot bearing 37 and with an extension towards the opposite cutting jaw 8, 6. In this way in each case (here: integrally) a securing element 45, 46 is formed by the cutting edges 6, 8.

In the end region arranged outwards from the cutting knife 40 with respect to the pivot bearing 37, the cutting jaw 6 forms a (first) actuation surface 47. The actuation surface 47 is oriented radially inwards with respect to the pivot bearing 37 and has an insertion curvature in the region of a projection 48.

The movable cutting jaw 6 has an actuation element, especially a protrusion or hook 49, which forms a (second) actuation surface 50 and is arranged in the region of the ratchet toothing 21 (on the end-side with respect to the pivot bearing 37 in a circumferential direction).

Via an opening spring 51, especially a tension spring 71, the cutting jaw 6 is biased in the opening direction. One spring base of the opening spring 51 is linked to the cutting jaw 6, while the other spring base of the opening spring 51 is linked to the base body 10, here to a transverse bolt 52 supported at least by the cutting jaw 8.

The cover plate 9 on its own or together with the cutting jaw 8 forms a spring chamber 53, in which a spring base of a support spring 54 is supported and possibly the support spring 54 is also partially guided. The other spring base of the support spring 54 directly forms a stop 55. During the movement of the cutting jaws 6, 8, the stop 55 formed by the support spring 54 contacts the cutting jaw 6, here a protrusion 56 of the same, while with more and more movement in the opening direction, the pre-tension of the support spring 55 increases. On the contrary, in the opening position of the cutting jaws 6, 8, the stop 55 contacts a stop of the base body 10, especially the cutting jaw 8 or the spring chamber 53, while a pre-tension remains, in which way the maximum length of the support spring 54 is limited. Accordingly, a closing movement of the cutting jaws 6, 8 from the opening position of the same into the closing position leads to the result that the protrusion 56 of the cutting jaw 6 moves away from the stop 55 while forming an increased clearance 69.

It can be seen in FIG. 2 that at the base body 10, here the cutting jaw 8, (third) receptacles 57, 58 for replacement cutting knives 59, 60 are provided, which in the simplest case may be threaded bores into which fixing screws 43, 44 for fixing the replacement cutting knives 59, 60 can be screwed.

A fixing lever 61 is pivotably supported by the hand lever 2 in a position neighboring the handle. With the manual actuation of the fixing lever 61 the hand levers 2, 3 can be arrested in the closing position. For example, the fixing lever 61 has an protrusion or transverse bolt which in the closing position of the hand levers 2, 3 enters into a recess of the base body 10 in such a way that the opening movement of the hand levers 2, 3 is form-lockingly blocked and is only possible when the fixing lever 61 is manually actuated (possibly against the bias of a spring).

An opening spring 62 biases the hand levers 2, 3 in the opening direction in such a way that when the actuation forces exerted on the hand levers 2, 3 are reduced or removed, the hand levers 2, 3 automatically enter into the opening position. In the figures the linkage of the opening spring 62, which here is formed as a leg spring, to the base body 10 on the one hand and to the movable hand lever 2 on the other hand is not shown in detail.

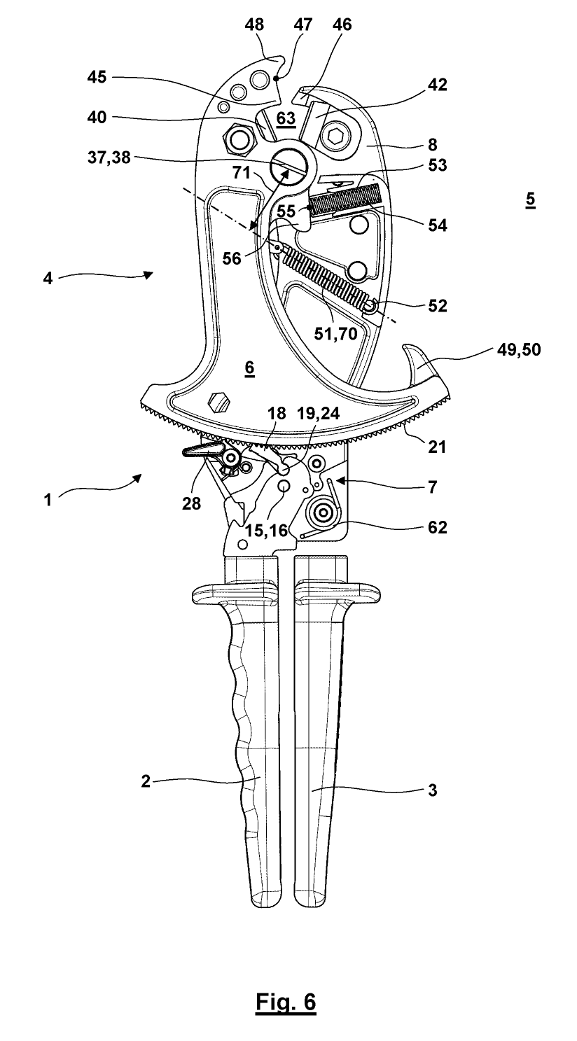

The functioning of the bolt cutter 1 when it is used is in the following explained according to the sequence of the FIGS. 6 to 10:

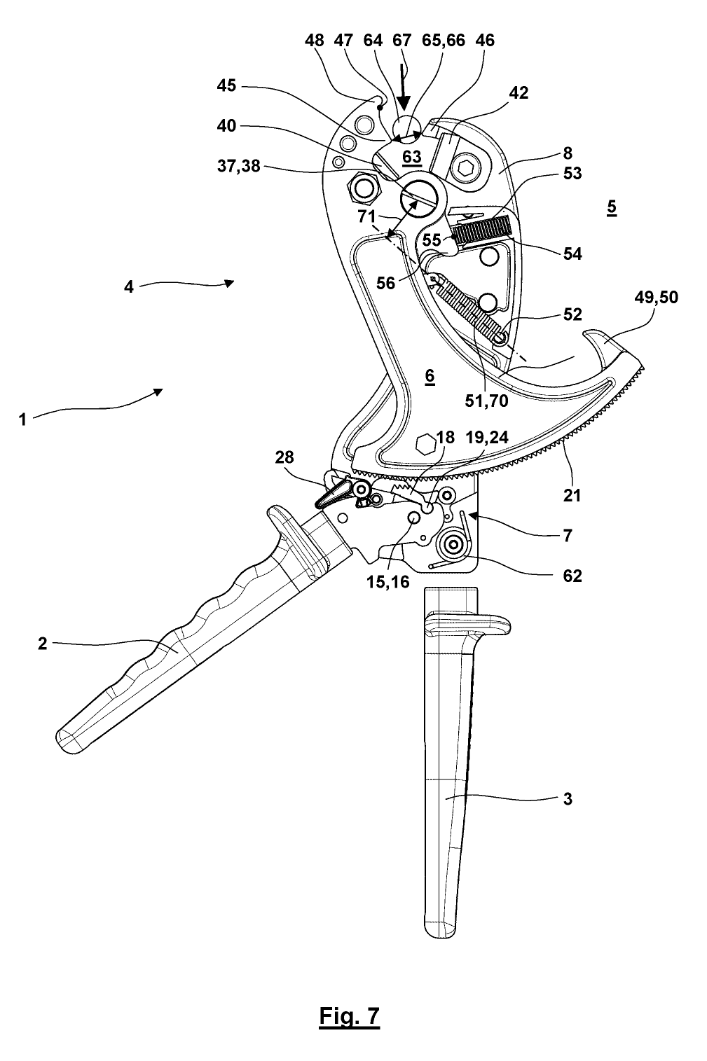

In FIG. 6, the bolt cutter 1 is in the opening position of the cutting jaws 6, 8, while the hand levers 2, 3 are in the closing position. Due to the engagement of the pushing rod 18 and the pawl 28 with their ratchet toothings 20, 29 with the ratchet toothing 21 of the cutting jaw 6, the opening position of the cutting jaws 6, 8 is fixed. For inserting a workpiece into a (first) receptacle 63 for the workpiece formed by the cutting knives 40, 42, the hand levers 2, 3 are moved into the opening position (due to the effect of the opening spring 62 and/or due to the manual moving of the hand levers 2, 3). By manually moving the pawl 28, additionally, the enlarged opening position of the hand levers 2, 3 may be achieved. For the enlarged opening position (as explained before and according to European patent application EP 15 191 264.9) the pushing rod 18 and the pawl 28 no longer engage the ratchet toothing 21 (FIG. 7). For the cutting jaw 6 thus unlocked, the cutting jaw 6 can be manually moved from the opening position according to FIG. 6 into an enlarged opening position according to FIG. 7. This can be done by the user directly exerting force on the cutting jaw 6 with his hand, which may for example be done by pulling on the actuation surface 50 of the protrusion or hook 49, which protrudes laterally from the head 4 and which is therefore accessible. Alternatively or additionally, it is possible that the user causes the movement of the cutting jaw 6 from the opening position into the enlarged opening position by use of a workpiece 64. To this end, the user can press the workpiece 64 against the actuation surface 47 in the opening direction of the cutting jaw 6. By the protrusion 48 and the curvature of the actuation surface 47 arranged there the insertion can be simplified. Then, the enlarged opening position of the cutting jaws 6, 8 as shown in FIG. 7 results. With the movement from the opening position of the cutting jaws 6, 8 according to FIG. 6 into the enlarged opening position of the cutting jaws 6, 8 according to FIG. 7, the support spring 45 is biased by displacing the stop 55 of the same by the cutting jaw 6 or the protrusion 56. In the enlarged opening position according to FIG. 7, the cutting jaws 6, 8 form an insertion opening 65 having an insertion cross-section 66. The insertion cross-section 66 is at least as large as the outer diameter of the workpiece 64 so that the workpiece 64 can be transferred to the receptacle 63 through the insertion opening 65 in an insertion direction 67. The insertion opening 65 or the insertion cross-section 66 is limited by the securing elements 45, 46. Due to the securing elements 45, 46 the insertion opening 65 merges to the receptacle 63 with an enlargement of the cross-section.

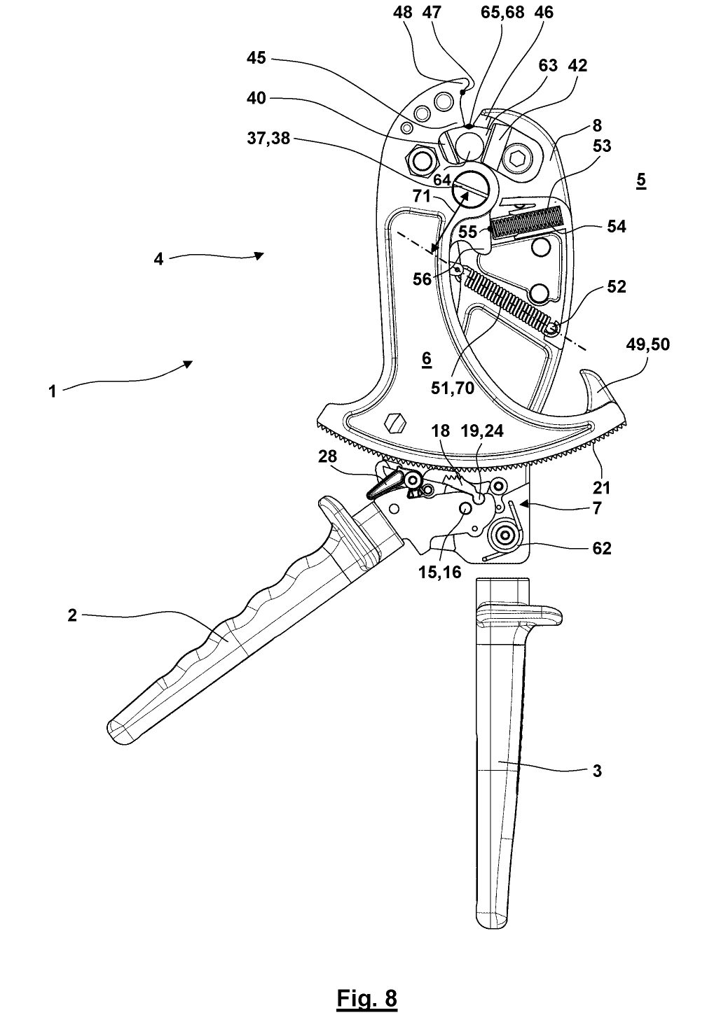

If the opening force manually exerted onto the cutting jaw 6 is removed, due to the effect of the support spring 54 the cutting jaw 6 returns to the opening position of the cutting jaws 6, 8 (FIG. 8). In the opening position of the cutting jaws 6, 8, the insertion opening 65 has a reduced insertion cross-section 68. The insertion cross-section 68 is dimensioned in such a way that the workpiece 64 cannot escape from the receptacle 63 through the insertion opening 65. This opening position of the cutting jaws 6, 8 is secured by the support spring 54 without the engagement of the pushing rod 18 and the pawl 28 with the ratchet toothing 21 of the cutting jaw 6 being compulsory. Therefore, in the opening position of the cutting jaws 6, 8, the workpiece 64 is held in the bolt cutter 1 secured against being lost and is prepared for the cutting stroke of the cutting jaws 6, 8. This is achieved by the securing elements 45, 46, here taking the form of the protrusions of the cutting jaws 6, 8 protruding over the cutting edges of the cutting knives 40, 42.

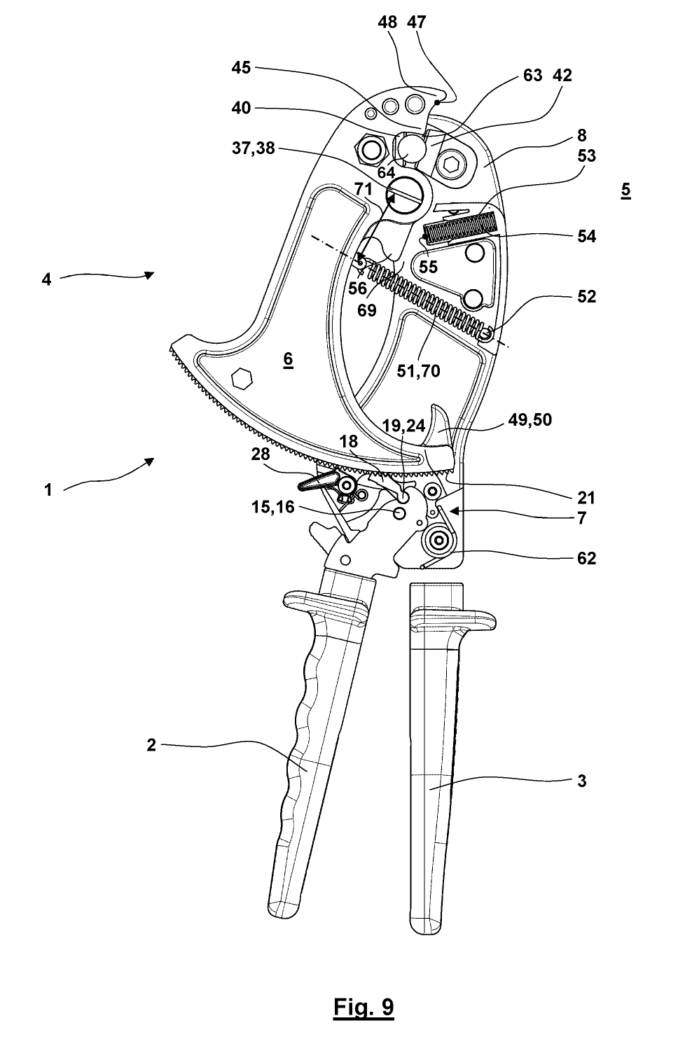

Before the actual closing movement of the cutting jaws 6, 8 occurs due to the successive closing movements of the hand levers 2, 3, the ratchet gear is to be activated first, which is achieved by bringing the hand lever 2 from the enlarged opening position into the opening position (as explained before and according to patent application EP 15 191 264.9). FIG. 9 shows the bolt cutter 1 during the cutting stroke of the cutting jaws 6, 8 from the opening position of the same into the closing position. During the cutting stroke, the hand levers 2, 3 are brought from the opening position into the closing position in several closing strokes of the same. In this way with every closing stroke of the hand levers 2, 3 via the ratchet gear 7 a partial stroke of the cutting stroke of the cutting jaws 6, 8 is caused. Between the individual closing strokes of the hand levers 2, 3, there is a movement of the hand levers 2, 3 back from the closing position into the opening position, in which the partial closing position of the cutting jaw 6 achieved is secured via the pawl 28, while the pushing rod 18 glides along the ratchet toothing 21 in a ratchet-like way. During the cutting stroke of the cutting jaws 6, 8, the support spring 54 does not follow the movement of the cutting jaw 6, so that between the stop 55 formed by the support spring 54 and the protrusion 56 of the cutting jaw 6 a clearance 69 is formed which increases as the closing goes forth.

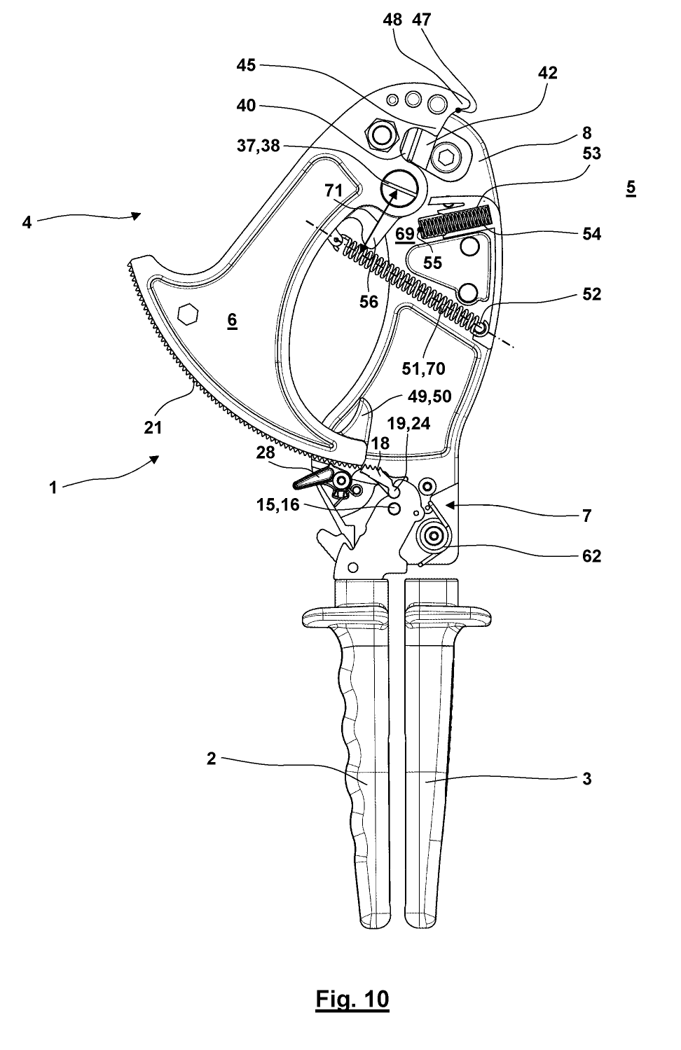

At the end of the cutting stroke of the cutting jaws 6, 8 (and the closing stroke of the hand levers 2, 3) according to FIG. 10, the cutting jaw 6 is pivoted into the closing direction to a maximum extent, in which way the cutting edges of the cutting knives 40, 42 contact each other and the workpiece 64 has been completely cut. This closing position correlates, as can be seen from FIG. 10, with the pushing rod 18 having reached the end of the ratchet toothing 21 so that with a further closing movement of the hand levers 2, 3 no further movement of the cutting jaw 6 or an increase of the closing force can be caused.

For the embodiment shown, the opening spring 51 is formed by a tension spring 70. The biasing of the tension spring 70 increases as the cutting jaws 6, 8 are closed farther. The tension spring 71 biases the cutting jaw 6 with a lever arm 71 with respect to the pivot bearing 37. This lever arm 71 increases as the cutting jaws 6, 8 are further closed. Therefore, in the opening position of the cutting jaws 6, 8 an opening force exerted by the tension spring 70 onto the cutting jaw 6 results, which is comparatively small and therefore can be supported against a support spring 54, which may have a comparatively small stiffness and/or be supported with small pre-tension in the opening position.

The overlap 11 in the region of which the cutting jaw 8, the hand lever 3 and the cover plate 9 are fixed against each other, here only extends on the side of the cutting jaw 6 and the ratchet toothing 21 turned towards the hand levers 2, 3. The cover plate 9 preferably ends at the level of the pivot bearing 37 or below the same, so that for the whole movement region of the movable cutting jaw 6 it does not cover the cutting knives 40, 42, the receptacles 39, 41 for the cutting knives 40, 42, the receptacle 63 and the securing elements 45, 46.

Preferably, the bolt cutter 1 according to the invention is manufactured with a modular production, where by using different partial modules different bolt cutters 1 or other types of pliers can be produced. To mention only a non-limiting example, by using the same hand levers 2, 3 and the same construction elements of the ratchet gear, a combination with crescent-shaped cutting knives is possible for which a further crescent-shaped movable cutting jaw forms the ratchet toothing 21. With respect to further details of such a modular embodiment of the bolt cutter 1 and other pliers reference is made to the (not pre-published) European patent application EP 15 191 261.5-1701, which with respect to the modular design is incorporated by reference into the present patent application.

It is optionally possible that in the enlarged opening position a latching or locking is possible via a latching device or locking device not shown here.

Many variations and modifications may be made to the preferred embodiments of the invention without departing substantially from the spirit and principles of the invention. All such modifications and variations are intended to be included herein within the scope of the present invention, as defined by the following claims.

I claim:

1. Bolt cutter for cutting a workpiece as a bolt comprising
a) a fixed hand lever and a movable hand lever,
b) a fixed cutting jaw, which is fixedly connected to the fixed hand lever, and
c) a movable cutting jaw which
ca) is supported pivotably relative to the fixed cutting jaw by a pivot bearing and
cb) is operatively connected via a ratchet gear to the movable hand lever, the ratchet gear being designed and configured for being automatically transferred into a released state at the end of a cutting stroke,
d) an opening spring connected to the movable cutting jaw and designed and configured for moving the movable cutting jaw into an opening position in the released state of the ratchet gear,
e) a stop supported by a support spring and defining the opening position of the movable cutting jaw by the establishing of a contact between the stop and the movable cutting jaw, where
ea) by manual application of a manual opening force upon the movable cutting jaw the movable cutting jaw is movable from the opening position into an enlarged opening position under an increasing bias of the support spring and
eb) due to the support spring the movable cutting jaw is automatically returned from the enlarged opening position to the opening position when the manual opening force is reduced or removed.

2. Bolt cutter according to claim 1, wherein the movable cutting jaw is operatively connected via the ratchet gear and a toggle lever drive to the movable hand lever.

3. Bolt cutter according to claim 1, wherein
a) cutting knives formed by the cutting jaws or mounted to the cutting jaws form a receptacle for the workpiece
b) in the enlarged opening position the receptacle comprises an insertion opening for inserting the workpiece into the receptacle in an inserting direction and
c) the movable cutting jaw has an actuation surface which is arranged in front of the receptacle when seen in the inserting direction so that for an insertion of a workpiece into the receptacle the manual opening force can be applied by the workpiece to the actuation surface of the movable cutting jaw.

4. Bolt cutter according to claim 1, wherein
a) the movable cutting jaw comprises a second actuation surface designed and configured for applying the manual opening force and
b) in the opening position the second actuation surface protrudes laterally from a head of the bolt cutter.

5. Bolt cutter according to claim 4, wherein
a) the movable cutting jaw comprises a ratchet toothing being a part of the ratchet gear,
b) an actuation element is formed or arranged in an outer end portion of the ratchet toothing of the movable cutting jaw and
c) the second actuation surface is formed by the actuation element.

6. Bolt cutter according to claim 1, wherein
a) cutting knives formed by the cutting jaws or mounted to the cutting jaws form a receptacle for the workpiece
b) in the enlarged opening position the receptacle comprises an insertion opening for inserting the workpiece into the receptacle in an inserting direction and
c) at least one of the cutting jaws comprises a securing element which in the opening position at least partially closes off the inserting opening to the receptacle for the workpiece.

7. Bolt cutter according to claim 1, wherein
a) cutting knives formed by the cutting jaws or mounted to the cutting jaws form a receptacle for the workpiece
b) in the enlarged opening position the receptacle comprises an insertion opening for inserting the workpiece into the receptacle in an inserting direction and
c) the insertion opening comprises a first insertion cross-section in the opening position and comprises a second insertion cross-section in the enlarged opening position, the first insertion cross-section being smaller than the cross-section of the workpiece and the second insertion cross-section being at least as large as the cross-section of the intended workpiece.

8. Bolt cutter according to claim 6, wherein the insertion opening comprises a first insertion cross-section in the opening position and a second insertion cross-section in the enlarged opening position, the first insertion cross-section being smaller than the cross-section of the workpiece and the second insertion cross-section being at least as large as the cross-section of the intended workpiece.

9. Bolt cutter according to claim 1, wherein
a) the opening spring exerts an opening moment upon the movable cutting jaw and
b) the opening moment decreases as a pivoting angle of the movable cutting jaw changes towards the opening position or the enlarged opening position.

10. Bolt cutter according to claim 9, wherein
a) the opening spring biases the movable cutting jaw with a lever arm in opening direction and
b) the lever arm decreases with a change of the pivoting angle of the movable cutting jaw towards the opening position or the enlarged opening position.

11. Bolt cutter according to claim 1, wherein
a) a head of the bolt cutter comprises three plates lying one above the other,
b) an outer first plate forms the fixed cutting jaw,
c) an outer second plate forms a covering plate and
d) a third plate arranged between the first and second plates forms the movable cutting jaw.

12. Bolt cutter according to claim 11, wherein a spring base of the support spring is supported by the covering plate, the covering plate forms a cover for the ratchet gear and the covering plate is only fixed to the fixed cutting jaw at a position or positions below the movable cutting jaw.

13. Bolt cutter according to claim 2, wherein
a) the movable hand lever is supported pivotably relative to the fixed hand lever by a second pivot bearing,
b) the movable hand lever comprises a hand lever part extending away from the second pivot bearing,
c) a pushing rod is linked by a third pivot bearing to an end portion of the hand lever part turned away from the second pivot bearing,
d) in the end portion turned away from the third pivot bearing the pushing rod comprises a second ratchet toothing, which engages with a ratchet toothing of the movable cutting jaw,
e) the hand lever part forms a first toggle lever, the pushing rod forms a second toggle lever, the third pivot bearing forms a toggle lever joint between the hand lever part and the pushing rod and the hand lever part, the pushing rod and the toggle lever joint together form the toggle lever drive.

14. Bolt cutter according to claim 1, wherein
a) a spring-loaded pawl cooperates with a ratchet toothing of the movable cutting jaw,
b) during a cutting stroke the spring-loaded pawl blocks an opening motion of the cutting jaws by engaging with the ratchet toothing of the movable cutting jaw and
c) after passing completely through the cutting stroke or after a manual unlocking of the pawl the spring-loaded pawl causes no blocking effect to the ratchet toothing of the movable cutting jaw so that an opening of the movable cutting jaw by the opening spring into the opening position or a manual opening of the movable cutting jaw into the enlarged opening position is possible.

15. Bolt cutter according to claim 13, wherein
a) a spring-loaded pawl cooperates with the ratchet toothing of the movable cutting jaw,
b) during a cutting stroke the spring-loaded pawl blocks an opening motion of the cutting jaws by engaging with the ratchet toothing of the movable cutting jaw and
c) after passing completely through the cutting stroke or after a manual unlocking of the pawl the spring-loaded pawl causes no blocking effect to the ratchet toothing of the movable cutting jaw so that an opening of the movable cutting jaw by the opening spring into the opening position or a manual opening of the movable cutting jaw into the enlarged opening position is possible.

16. Bolt cutter according to claim 1, wherein a cutting knife is detachably fixed to one of the cutting jaws.

17. Bolt cutter according to claim 16, wherein
a) the cutting jaw comprises a second receptacle,
b) the cutting knife is inserted into the second receptacle and
c) the cutting knife is fitted accurately in the second receptacle.

18. Bolt cutter according to claim 16, wherein a third receptacle for accommodating a replacement cutting knife is provided.
